(19) United States
(12) Patent Application Publication
(10) Pub. No.: US 2020/0221731 A1
(43) Pub. Date: Jul. 16, 2020

(54) MEANS FOR INCREASING METHIONINE BIOAVAILABILITY

(71) Applicant: Novus International, Inc., St. Charles, MO (US)

(72) Inventors: Heather Tucker, St. Charles, MO (US); Cristina Maldonado, St. Charles, MO (US); Antonio Viso, St. Charles, MO (US)

(21) Appl. No.: 16/738,243

(22) Filed: Jan. 9, 2020

Related U.S. Application Data
(60) Provisional application No. 62/791,312, filed on Jan. 11, 2019.

(51) Int. Cl. A23K 20/105; A23K 50/10; A23K 20/111; A23K 20/158; A23K 40/35

(52) U.S. Cl. CPC A23K 20/105; A23K 50/10; A23K 20/163; A23K 20/158; A23K 40/35; A23K 20/111

(57) ABSTRACT

Compositions for improving the bioavailability of methionine. In general, the compositions comprise a source of methionine and essential oil(s). More specifically, the compositions comprise a source of methionine and a plurality of coated particles comprising essential oils. Administration of said compositions improves animal health and performance, e.g., increased fermentation in ruminants or increased milk fat and/or milk protein in lactating ruminants.

### CROSS-REFERENCE TO RELATED APPLICATIONS

This application claims the benefit of U.S. Provisional Application No. 62/791,312, filed Jan. 11, 2019, which is hereby incorporated by reference in its entirety.

### FIELD

The present disclosure provides compositions and methods for improving the bioavailability of methionine. The compositions comprise a source of methionine and essential oils. Said compositions improve animal health and performance.

### BACKGROUND

Dietary methionine is indispensable for animal maintenance, growth, and development. L-methionine (L-Met), and its synthetic forms DL-methionine (DL-Met) and 2-hydroxy-4 (methylthio) butanoic acid (HMTBA) are common supplemental methionine sources in animal diets. While all three dietary sources of methionine are effective, means are needed for increasing methionine bioavailability, thereby decreasing the costs and increasing the efficiency of methionine supplementation. Thus, there is a need for compositions that provide increased bioavailability of methionine.

### SUMMARY

In general, the disclosure provides compositions comprising a source of methionine and essential oils. One aspect of the present disclosure provides a composition comprising a source of methionine and a plurality of coated particles, wherein the plurality of coated particles comprises at least one essential oil. In general, the plurality of coated particles may comprise a core comprising the at least one essential oil and a protective coating over the core, wherein the core comprises inert material and the protective coating comprises amphiphilic compounds.

Also provided are methods of administering the composition to a subject to improve at least one performance parameter.

Other aspects and iterations of the disclosure are described in more detail below.

### BRIEF DESCRIPTION OF THE DRAWINGS

FIG. 1A presents the level of propionate produced in a continuous culture system in the presence of MHA (left) or composition #1 (right). P=0.0014.

FIG. B shows the level of butyrate produced in a continuous culture system in the presence of MHA (left) or composition #1 (right).

FIG. 1C presents the level of acetate produced in a continuous culture system in the presence of MHA (left) or composition #1 (right).

FIG. 2A shows the ratio of acetate:propionate produced in a continuous culture system in the presence of MHA (left) or composition #1 (right). P=0.0070.

FIG. 2B presents the total level of volatile fatty acids (VFA) produced in a continuous culture system in the presence of MHA (left) or composition #1 (right). P=0.0756.

### DETAILED DESCRIPTION

The present disclosure provides compositions comprising a source of methionine and one or more essential oils, wherein the essential oils increase methionine bioavailability in animals. Also provided are feed premixes and/or feed rations comprising the compositions disclosed herein, as well as methods of providing said compositions to animals to increase animal health and performance.

### (I) Composition Comprising Methionine Source and Two or More Essential Oils

One aspect of the present disclosure is the provision of compositions comprising a source of methionine and at least two essential oils. The essential oils in the composition increase the bioavailability of the source of methionine, as shown below in the Examples.

### (I)(a) Source of Methionine

The compositions disclosed herein comprise a source of methionine. The methionine may be natural, synthetic, or an analog thereof. The methionine may be D-methionine, L-methionine, or D,L-methionine, or analog of any of the foregoing.

In some embodiments, the source of methionine comprises compounds of Formula (I):

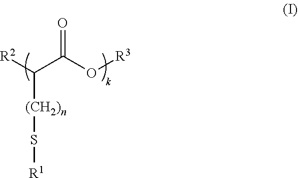

wherein:
   R¹ is alkyl or substituted alkyl;
   R² is NH₂ or OH;
   R³ is hydrogen, alkyl, substituted alkyl, or a metal ion;
   k is an integer of 1 or greater; and
   n is an integer of 1 or greater.

In some embodiments, R¹ may be C₁ to C₆ alkyl or C₁ to C₆ substituted alkyl. The alkyl may be straight chain or branched. The substituted alkyl comprises a replacement of one or more carbon and/or hydrogen atoms with a nitrogen, oxygen, phosphorous, or halogen heteroatom. In various embodiments, R¹ may be methyl, ethyl, propyl, isopropyl, butyl, tert-butyl, hexyl, and the like. In other embodiments, R¹ may be methyl or ethyl. In specific embodiments, R¹ may be methyl.

In some embodiments, R³ may be hydrogen, C₁ to C₆ alkyl, C₁ to C₆ substituted alkyl, or a metal ion. The alkyl may be straight chain or branched. The substituted alkyl comprises a replacement of one or more carbon and/or hydrogen atoms with a nitrogen, oxygen, phosphorous, or halogen heteroatom. In some embodiments, R³ may be hydrogen. In other embodiments, R³ may be methyl, ethyl, propyl, isopropyl, butyl, tert-butyl, hexyl, and the like. In one embodiment, R³ may be isopropyl. In further embodiments, R³ may be a metal ion. The metal ion may be an alkali metal ion or an alkaline earth metal ion. For example, the metal ion may be calcium, chromium, cobalt, copper, iron, magnesium, manganese, silver, sodium, or zinc. The metal ion may be shared by more than one compound of Formula (I). In a particular embodiment, R³ may be calcium.

In certain embodiments, n may range from 1 to 10. In other embodiments, n may be 1, 2, 3, 4, or 5. In specific embodiments, n may be 1 or 2. In particular embodiments, n may be 2.

In general, k may range from 1 to about 100. In certain embodiments, k may range from 1 to about 50, from 1 to about 25, from 1 to about 20, from 1 to about 15, from 1 to about 10, from 1 to 9, from 1 to 8, from 1 to 7, from 1 to 6, from 1 to 5, from 1 to 4 or from 1 to 3, or from 1 to 2. In some embodiments, k may be the same in every compound of the formulation (e.g., k may be 1, k may be 2, etc.). In other embodiments, k may differ between the compounds of the formulation (e.g., k may be 1-4, 1-10, 1-20, and so forth). In such embodiments, the compounds of Formula (I) comprise a mixture of monomer, dimers, trimers, tetramers, and longer oligomers.

In some embodiments, R¹ is methyl, R² is NH₂, R³ is hydrogen, n is 2, and k is 1 or k ranges from about 1-10. In specific embodiments, R¹ is methyl, R² is OH, R³ is hydrogen, n is 2, and k is 1 or k ranges from about 1-10.

The compounds of Formula (I) may have at least one chiral center, as denoted with an asterisk in the schematic below:

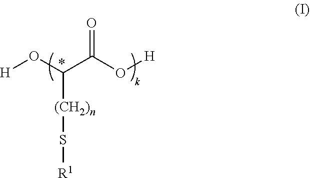

wherein R¹, k, and n are as defined above. Each chiral center may have an R or an S configuration. In compounds comprising one chiral carbon, the configuration may be R or S. In compounds comprising two or more chiral carbons, the configuration of each will be independently R or S. For example, in compounds comprising two chiral carbons, the configuration may be RR, RS, SR, or SS, in compounds comprising three chiral carbons, the configuration may be RRR, RRS, RSR, RSS, SRR, SRS, SSR, or SSS, and so forth.

The amount of the source of methionine present in the compositions disclosed herein can and will vary. In general, the concentration of the source of methionine may range from about 90% to about 99% by weight of the composition. In various embodiments, the composition may comprise about 90%, about 91%, about 92%, about 93%, about 94%, about 95%, about 96%, about 97%, about 98%, or about 99% by at least about 95%, at least about 96%, at least about 97%, about at least about 98%, at least about 99% by weight of the composition. In certain embodiments, the amount of the source of methionine in the composition may range from about 95% to about 98% or from about 96% to about 97% by weight of the composition.

### (I)(b) Essential Oils

Essential oils, also known as volatile oils or ethereal oils, are concentrated hydrophobic liquids containing volatile aroma compounds obtained from fruits, seeds, flowers, bark, stems, roots, leaves, or other parts of a plant. Essential oils are generally obtained by distillation (e.g., steam distillation), solvent extraction, expression, and/or cold pressing. The specific chemical compound imparting the “essence of” of the plant's fragrance may be isolated from the plant, or it may be chemically synthesized. The term “essential oil” generally refers to the specific chemical compound of which the essential oil is composed, but can also refer to the oil of the plant from which it was extracted

A variety of essential oils may be included in the compositions. Suitable essential oil compounds include allicin, amyl cinnamic aldehyde, amyl salicylate, anethole, anisic aldehyde, borneol, bornyl acetate, cadinene, camphene, camphor, carvacrol, carveol, carvone, cinnamaldehyde (or cinnamic aldehyde), cineol, citral, citronellal, citronellol, cuminic alcohol, cuminic aldehyde, cymene, dipentene, estragol, ethyl vanillin, eucalyptol, eugenol, eugenyl acetate, geraniol, geranyl acetate, guaiacol, isoeugenol, limonene, linalool, linalyl acetate, listea cubea, menthol, menthyl salicylate, methylchavicol, methyl salicylate, paracymene, perillaldehyde, phellandrene, pinene, piperonal, piperonyl acetate, piperonyl alcohol, pulegone, sabinene, terpinene, terpineol, terpinyl acetate, thujone, thymol, vanillin, and combinations thereof. Suitable essential oils also include aloe essential oil, angelica essential oil, anise essential oil, basil essential oil, bay essential oil, bergamot essential oil, birch essential oil, blueberry essential oil, bois de rose essential oil, cade essential oil, camphor essential oil, cananga essential oil, caraway essential oil, cardamom essential oil, carrot essential oil, cedar essential oil, cedarwood essential oil, celery essential oil, Chamaecyparis obtusa essential oil, chamomile essential oil, chive essential oil, cinnamon essential oil, citronella essential oil, clove essential oil, copaiba balsam essential oil, coriander essential oil, cumin essential oil, dill essential oil, eucalyptus essential oil, fennel essential oil, garlic essential oil, geranium essential oil, ginger essential oil, ginseng essential oil, grapefruit essential oil, guaiacwood essential oil, Hiba essential oil, ho camphor essential oil, hyssop essential oil, iris essential oil, Japanese mint essential oil, jasmine essential oil, juniper essential oil, laurel essential oil, lavender essential oil, leek essential oil, lemon essential oil, lemongrass essential oil, lime essential oil, linaloe essential oil, Lindera essential oil, marjoram essential oil, mandarin essential oil, mint essential oil, myrrh essential oil, myrthe essential oil, Neroli essential oil, nutmeg essential oil, oak essential oil, onion essential oil, orange essential oil, palmarosa essential oil, palmarosa sofia essential oil, papaya essential oi, paprika essential oil, parsley essential oil, patchouli essential oil, pepper essential oil, peppermint essential oil, perilla essential oil, Peru balsam essential oil, petitgrain essential oil, pine needle essential oil, red pepper essential oil, rose essential oil, rosemary essential oil, rosewood essential oil, sage essential oil, sandalwood essential oil, sesame essential oil, shallot essential oil, spearmint essential oil, spice plant essential oil, star anise essential oil, sweet orange essential oil, tangerine essential oil, tea seed essential oil, tea tree essential oil, thyme essential oil, tolu balsam essential oil, tuberose essential oil, turmeric essential oil, vetivert essential oil, Western mint essential oil, wintergreen essential oil, and combinations of any of the foregoing.

In general, the compositions disclosed herein comprise at least one essential oil. In some embodiments, the compositions may comprise two essential oils. In other embodiments, the compositions may comprise three essential oils. In still other embodiments, the compositions may comprise four essential oils. In yet additional embodiments, the compositions may comprise five, six, seven, or more than seven essential oils.

The amount of the essential oil(s) present in the composition can and will vary depending upon, for example, the identity of the essential oil(s). In general, the amount of the essential oil(s) present in the compositions disclosed herein may range from about 0.1% to about 10% by weight. In certain embodiments, the composition may comprise from about 0.1% to about 0.3%, from about 0.3% to about 1%, from about 1% to about 3%, or from about 3% to about 10% by weight of the composition. In some embodiments, the composition may comprise from about 0.05% to about 5%, from about 0.5% to about 2%, from about 1% to about 3%, from about 1.5% to about 2%, or about 1.75% by weight of the composition.

In specific embodiments, the composition may comprise or consist of two essential oils. The total amount of the two essential oils may be about 1.75% by weight of the composition. In one embodiment, the two essential oils may be cinnamaldehyde and garlic oil. The amount of cinnamaldehyde in the composition may be about 1.5% by weight of the composition and the amount of garlic oil may be about 0.25% by weight of the composition. In another one embodiment, the two essential oils may be thymol and carvacrol. The amount of thymol in the composition may be about 0.875%% by weight of the composition and the amount of garlic oil may be about 0.875% by weight of the composition.

### (I)(c) Physical Form

In general, the compositions disclosed herein are solid in form. In various embodiments, the compositions may be powdered, granulated, pelleted, and so forth. In specific embodiments, the composition may be a free flowing powder. The compositions generally comprise less than about 1% of water by weight.

### (II) Compositions Comprising Methionine Source and Coated Particles Comprising One or More Essential Oils

Another aspect of the present disclosure encompasses compositions that comprise a methionine source and a plurality of coated particles that comprise at least one essential oil.

### (II)(a) Source of Methionine

The source of methionine is described above in section (I)(a). The amount of the methionine source present in the compositions can and will vary. In general, the concentration of the source of methionine may range from about 90% to about 99% by weight of the composition. In various embodiments, the composition may comprise about 90%, about 91%, about 92%, about 93%, about 94%, about 95%, about 96%, about 97%, about 98%, or about 99% by at least about 95%, at least about 96%, at least about 97%, about at least about 98%, at least about 99% by weight of the composition. In certain embodiments, the amount of the source of methionine in the composition may range from about 95% to about 98% or from about 96% to about 97% by weight of the composition.

### (II)(b) Coated Particles Comprising Essential Oils

The coated particles comprise a core comprising the one or more essential oils (also called oil-laden core) and a protective coating layered over the oil-laden core.

In general, the amount of the coated particles present in the compositions may range from about 1% to about 10% by weight of the composition. In certain embodiments, the composition may comprise about 1%, about 2%, about 3%, about 4%, about 5%, about 6%, about 7%, about 8%, about 9%, or about 10% by weight of the coated oil particles. In specific embodiments, the amount of the coated particles in the composition may range from about 2% to about 5% or from about 3% to about 4% by weight of the composition.

The components (i.e., core, essential oils, and protective coating layer) of the coated particles are described below.

### (i) Core

The core of the coated particles is generally inert, meaning that it core does not react with the essential oil(s) and does not cause or induce any degradation process. The core is a solid material. In general, the solid material comprises porous particles, which have increased surface area relative to a nonporous particle of similar size. The core may be organic, inorganic, or a combination thereof. Non-limiting examples of suitable organic core materials include sucrose, lactose, starches, microcrystalline cellulose, or combinations thereof. Examples of inorganic materials suitable for the core include, without limit, silicon dioxide, aluminum oxide, calcium oxide, magnesium oxide, titanium oxide, zinc oxide, clays, metal oxides, metal silicates, metal carbonates, metal phosphonates, metal sulfates, metal carbides, metal nitrides, and combinations thereof. In certain embodiments, the inert core is inorganic. In specific embodiments, the core may comprise silicon dioxide (i.e., silica).

The core may comprise from about 30% to about 45% by weight of the particles. In certain embodiments, the core may comprise about 35% to about 40% by weight of the particles. In specific embodiments, the core may comprise about 37% by weight of the particles.

In general, the core of the particles, prior to coating, has an average diameter from about 50 microns to about 1000 microns. In specific embodiments, the core has an average diameter from about 80 microns to about 500 microns, or the core has an average diameter from about 90 microns to about 300 microns.

### (ii) Essential Oils

Suitable essential oils are detailed above in section (I)(b). The one or more essential oils are adsorbed and/or absorbed onto the cores of the particles. In general, the one or more essential oils are deposited on the surface of the porous core particles by spraying (as detailed below). As such, the essential oil(s) are deposited on the surface and within the pores of the porous support, thereby forming oil-laden cores.

The amount of the essential oil(s) present in the particles can and will vary depending, for example, upon the identity of the essential oil and/or the identity of the inert core material. In general, the amount of the at least one essential oil present in the particles may range from about 40% to about 60% by weight of the particles. In some embodiments, the amount of the at least one essential oil present in the particles may range from about 45% to about 55% by weight of the particles. In specific embodiments, the amount of the at least one essential oil present in the particles may be about 45%, about 46%, about 47%, about 48%, about 49%, about 50%, about 51%, about 52%, about 53%, about 54%, or about 55% by weight of the particles. In specific embodiments, the amount of the at least one essential oil present in the particles may be about 50% by weight of the particles.

In some embodiments, the particles may comprise one essential oil. In other embodiments, the particles may comprise two essential oils. In further embodiments, the particles may comprise three essential oils. In alternate embodiments, the particles may comprise four essential oils. In yet additional embodiments, the particles may comprise five, six, seven, or more than seven essential oils.

In specific embodiments, the particles may comprise two essential oils. Without being bound by any particular theory, it is believed that the two essential oils are synergistic and/or one of the essential oils slows or prevents degradation of the other essential oil in the particles. The weight ratio of the first to the second essential oil may range from about 0.1:1 to about 100:1. For example, the weight ratio of the first to the second essential oil may be about 0.1:1, 0.3:1, 1:1, 3:1, 10:1, 30:1, or 100:1.

In one embodiment, the two essential oils may be thymol and carvacrol. Typically, thymol and carvacrol are present in about equal amounts (i.e., a 1:1 weight ratio). For example, in embodiments in which the two essential oils are present in the particles at about 50% by weight of the particles, the amount of thymol is about 25% by weight of the particles and the amount of carvacrol is about 25% by weight of the particles.

In another embodiment, the two essential oils may be cinnamaldehyde and garlic oil. The weight ratio of cinnamaldehyde to garlic oil may range from about 5:1 to about 7:1. In some embodiments, the weight ratio of cinnamaldehyde to garlic oil may be about 6.1:1. For example, in embodiments in which the two essential oils are present in the particles at about 50% by weight of the particles, the amount of cinnamaldehyde is about 43% by weight of the particles and the amount of garlic oil is about 7% by weight of the particles.

### (iii) Protective Coating

The particles also comprise a protective coating that is layered over the oil comprising the essential oil(s) such that the oil-laden core is encapsulated by the protective coating. In general, the protective coating comprises amphiphilic compounds. Thus, the lipophilic-hydrophilic nature of the protective coating may protect the essential oils from oxidative damage and may help regulate release of the essential oils. In particular, the lipophilic component of the coating materials prevents release of the essential oils until the appropriate target in the gastrointestinal tract is reached, at which point the hydrophilic component of the coating materials permits controlled release of the essential oils.

Suitable amphiphilic compounds that may be used in the protective coating layer include fatty acids, monoglycerides of fatty acids, diglycerides of fatty acids, esters thereof, or combinations thereof. Said amphiphilic compounds may be from plant sources or animal sources. The fatty acids, diglycerides of fatty acids, or esters thereof are generally solid at room temperature, and have melting temperatures of about 70° C. or greater. In general, the fatty acids are long chain fatty acids, meaning they contain 14 or more carbon atoms. Suitable esters of mono- or diglycerides of fatty acid include acetic, lactic, citric, and/or tartaric acid esters. In some embodiments, the protective coating may comprise a mixture of mono- and diglycerides of long chain fatty acids or esters thereof. In specific embodiments, the protective coating may comprise a mixture of mono- and diglycerides of stearic acid and/or palmitic acid.

The amount of protective coating layered over the core comprising the essential oil(s) may vary. In general, the amount of the protective coating may range from about 10% to about 15% by weight of the particles. In various embodiments, the protective coating may comprise about 10%, about 11%, about 12%, about 13%, about 14%, or about 15% by weight of the particles. In specific embodiments, the amount of the protective coating may be about 13% by weight of the particles.

### (iv) Preparation of Particles

The essential oil particles may be prepared by depositing the essential oil(s) on the inert cores to form oil-laden cores, and then encapsulating the oil-laden cores with a layer of protective coating.

The one or more essential oils may be deposited on the inert cores by spraying the inert cores with the essential oils. In some embodiments, the essential oils may be combined with a solvent to form a spraying solution. For example, the solvent may be a nonpolar solvent. Non-limiting examples of suitable nonpolar solvents include benzene, butyl acetate, tert-butyl methyl ether, chlorobenzene, chloroform, chloromethane, cyclohexane, dichloromethane, dichloroethane, di-tert-butyl ether, dimethyl ether, diethylene glycol, diethyl ether, diglyme, diisopropyl ether, ethyl tert-butyl ether, ethylene oxide, fluorobenzene, heptane, hexane, methyl tert-butyl ether, toluene, and combinations thereof. In other embodiments, the essential oils may be sprayed onto the core without the use of a solvent.

The one or more essential oils may be sprayed over the core particles in a fluid bed reactor, a rolling drum reactor, or a suitable mixing system. In general, the essential oils are sprayed through a nozzle of a suitable spray system. The spraying generally is conducted at a temperature from about 15° C. to about 40° C. Upon completion of the spraying, the solvent may be removed from the oil-laden particles by vacuum drying at a temperature of about 30° C. or less.

The oil-laded particles are then spray coated with the protective coating at a temperature at which the coating material is liquid. In general, the protective coating is deposited on the oil-laden particles at a temperature from about 70° C. to about 85° C. The protective coating may be applied in a fluid bed reactor, a rolling drum reactor, or a suitable mixing system.

### (II)(c) Exemplary Compositions

Specific compositions comprise compounds of Formula (I) in which R¹ is methyl, R² is OH, R³ is calcium, n is 2, and k is 1, and essential oil particles comprising a silicon dioxide core loaded with two essential oils and encapsulated by a protective coating comprising mono- and diglycerides of C16 and C18 fatty acids. The compositions may comprise about 96.5% by weight of the compounds of Formula (I) and about 3.5% by weight of the essential oil particles.

In one embodiment the two essential oils may be thymol and carvacrol, wherein the essential oil particles comprise 25% thymol, 25% carvacrol, 37% silicon dioxide, and 13% protective coating by weight of the particles. Thus, the final concentration of thymol in the composition may be about 0.875% and the final concentration of carvacrol in the composition may be about 0.875% by weight of the composition.

In another embodiment the two essential oils may be cinnamaldehyde and garlic oil, wherein the coated particles comprise 43% cinnamaldehyde, 7% garlic oil, 37% silicon dioxide, and 13% protective coating by weight of the particles. As such, the final concentration of cinnamaldehyde in the composition may be is about 1.5% and the final concentration of garlic oil in the composition may be about 0.25% by weight of the composition.

### (III) Methods for Preparing the Compositions

Another aspect of the present disclosure provides methods for preparing the compositions described above in sections (I) and (II). In general, the methionine source may be blended with the essential oil(s) or coated particles by mixing, roller mixing, drum mixing, shear mixing, blending, dry blending, chopping, milling, roller milling, granulating, dry granulating, wet granulating, fluid bed granulating, and other mixing techniques known in the art. Suitable ratios of the various components are detailed above in sections (I) and (II).

### (IV) Feed Premixes

A further aspect of the present disclosure encompasses an animal feed premix or feed supplement comprising any of the compositions described above in Sections (I) or (II). Typically, the premix will be added to various feed formulations to formulate animal feed rations, as detailed below in Section (V). As will be appreciated by the skilled artisan, the particular premix or supplement can and will vary depending upon the feed ration and animal that the feed ration will be fed to. Accordingly, the premix or supplement may comprise a composition described in Sections (I) or (II) and at least one additional agent.

Examples of suitable additional agents include vitamins, minerals, amino acids or amino acid analogs, antioxidants, organic acids, polyunsaturated fatty acids, enzymes, prebiotics, probiotics, postbiotics, herbs, pigments, approved antibiotics, or combinations thereof.

In some embodiments, the additional agents may be one or more vitamins. Suitable vitamins include vitamin A, vitamin B1 (thiamine), vitamin B2 (riboflavin), vitamin B3 (niacin), vitamin B5 (pantothenic acid), vitamin B6 (pyridoxine), vitamin B7 (biotin), vitamin B9 (folic acid), vitamin B12, vitamin C, vitamin D, vitamin E, vitamin K, other B-complex vitamins (e.g., choline, carnitine, adenine), or combinations thereof. The form of the vitamin may include salts of the vitamin, derivatives of the vitamin, compounds having the same or similar activity of a vitamin, and metabolites of a vitamin.

In further embodiments, the additional agent may be one or more amino acids. Non-limiting suitable amino acids include standard amino acids (i.e., alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine), non-standard amino acids (e.g., L-DOPA, GABA, 2-aminobutyric acid, and the like), amino acid analogs (e.g., alpha hydroxy analogs), or combinations thereof.

In alternate embodiments, the additional agent may be one or more antioxidants. Suitable antioxidants include, but are not limited to, ascorbic acid and its salts, ascorbyl palmitate, ascorbyl stearate, anoxomer, N-acetylcysteine, benzyl isothiocyanate, m-aminobenzoic acid, o-aminobenzoic acid, p-aminobenzoic acid (PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline (ethoxyquin), ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate, flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, n-hydroxysuccinic acid, hydroxytryrosol, hydroxyurea, rice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., lonox 100), 2,4-(tris-3′,5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivatives thereof, vitamin Q10, wheat germ oil, zeaxanthin, or combinations thereof.

In still other embodiments, the additional agent may be one or more organic acids. The organic acid may be a carboxylic acid or a substituted carboxylic acid. The carboxylic acid may be a mono-, di-, or tri-carboxylic acid. In general, the carboxylic acid may contain from about one to about twenty-two carbon atoms. Suitable organic acids, by way of non-limiting example, include acetic acid, adipic acid, butanoic acid, benzoic acid, cinnamaldehyde, citric acid, formic acid, fumaric acid, glutaric acid, glycolic acid, lactic acid, malic acid, mandelic acid, propionic acid, sorbic acid, succinic acid, tartaric acid, or combinations thereof. Salts of organic acids comprising carboxylic acids are also suitable for certain embodiments. Representative suitable salts include the ammonium, magnesium, calcium, lithium, sodium, potassium, selenium, iron, copper, and zinc salts of organic acids.

In yet other embodiments, the additional agent may be one or more polyunsaturated fatty acids. Suitable polyunsaturated fatty acids (PUFAs) include long chain fatty acids with at least 18 carbon atoms and at least two carbon-carbon double bonds, generally in the cis-configuration. In specific embodiments, the PUFA may be an omega fatty acid. The PUFA may be an omega-3 fatty acid in which the first double bond occurs in the third carbon-carbon bond from the methyl end of the carbon chain (i.e., opposite the carboxyl acid group). Suitable examples of omega-3 fatty acids include all-cis 7,10,13-hexadecatrienoic acid; all-cis-9,12,15-octadecatrienoic acid (alpha-linolenic acid, ALA); all-cis-6,9,12,15,-octadecatetraenoic acid (stearidonic acid); all-cis-8,11,14,17-eicosatetraenoic acid (eicosatetraenoic acid); all-cis-5,8,11,14,17-eicosapentaenoic acid (eicosapentaenoic acid, EPA); all-cis-7,10,13,16,19-docosapentaenoic acid (clupanodonic acid, DPA); all-cis-4,7,10,13,16,19-docosahexaenoic acid (docosahexaenoic acid, DHA); all-cis-4,7,10,13,16,19-docosahexaenoic acid; and all-cis-6,9,12,15,18,21-tetracosenoic acid (nisinic acid). In an alternative embodiment, the PUFA may be an omega-6 fatty acid in which the first double bond occurs in the sixth carbon-carbon bond from the methyl end of the carbon chain. Examples of omega-6 fatty acids include all-cis-9,12-octadecadienoic acid (linoleic acid); all-cis-6,9,12-octadecatrienoic acid (gamma-linolenic acid, GLA); all-cis-11,14-eicosadienoic acid (eicosadienoic acid); all-cis-8,11,14-eicosatrienoic acid (dihomo-gamma-linolenic acid, DGLA); all-cis-5,8,11,14-eicosatetraenoic acid (arachidonic acid, AA); all-cis-13,16-docosadienoic acid (docosadienoic acid); all-cis-7,10,13,16-docosatetraenoic acid (adrenic acid); and all-cis-4,7,10,13,16-docosapentaenoic acid (docosapentaenoic acid). In yet another alternative embodiment, the PUFA may be an omega-9 fatty acid in which the first double bond occurs in the ninth carbon-carbon bond from the methyl end of the carbon chain, or a conjugated fatty acid, in which at least one pair of double bonds are separated by only one single bond. Suitable examples of omega-9 fatty acids include cis-9-octadecenoic acid (oleic acid); cis-11-eicosenoic acid (eicosenoic acid); all-cis-5,8,11-eicosatrienoic acid (mead acid); cis-13-docosenoic acid (erucic acid), and cis-15-tetracosenoic acid (nervonic acid). Examples of conjugated fatty acids include 9Z,11 E-octadeca-9,11-dienoic acid (rumenic acid); 10E,12Z-octadeca-9,11-dienoic acid; 8E,10E,12Z-octadecatrienoic acid (a-calendic acid); 8E,10E,12E-octadecatrienoic acid (3-Calendic acid); 8E,10Z,12E-octadecatrienoic acid (jacaric acid); 9E,11E,13Z-octadeca-9,11,13-trienoic acid (α-eleostearic acid); 9E,11E,13E-octadeca-9,11,13-trienoic acid (B-eleostearic acid); 9Z,11Z,13E-octadeca-9,11,13-trienoic acid (catalpic acid), and 9E,11Z,13E-octadeca-9,11,13-trienoic acid (punicic acid).

In still other embodiments, the additional agent may be one or more probiotics, prebiotics, or postbiotics. Probiotics, prebiotics, and postbiotics include agents derived from yeast or bacteria that promote good digestive health. By way of non-limiting example, yeast-derived probiotics, prebiotics, and postbiotics include yeast cell wall derived components such as β-glucans, arabinoxylan isomaltose, agarooligosaccharides, lactosucrose, cyclodextrins, lactose, fructooligosaccharides, laminariheptaose, lactulose, β-galactooligosaccharides, mannanoligosaccharides, raffinose, stachyose, oligofructose, glucosyl sucrose, sucrose thermal oligosaccharide, isomalturose, caramel, inulin, and xylooligosaccharides. In an exemplary embodiment, the yeast-derived agent may be β-glucans and/or mannanoligosaccharides. Sources for yeast cell wall derived components include Saccharomyces bisporus, Saccharomyces boulardii, Saccharomyces cerevisiae, Saccharomyces capsularis, Saccharomyces delbrueckii, Saccharomyces fermentati, Saccharomyces lugwigii, Saccharomyces microellipsoides, Saccharomyces pastorianus, Saccharomyces rosei, Candida albicans, Candida cloaceae, Candida tropicalis, Candida utilis, Geotrichum candidum, Hansenula americana, Hansenula anomala, Hansenula wingei, and Aspergillus oryzae. Probiotics, prebiotics, and postbiotics may also include bacteria cell wall derived agents such as peptidoglycan and other components derived from gram-positive bacteria with a high content of peptidoglycan. Exemplary gram-positive bacteria include Lactobacillus acidophilus, Bifedobact thermophilum, Bifedobat longhum, Streptococcus faecium, Bacillus pumilus, Bacillus subtilis, Bacillus licheniformis, Lactobacillus acidophilus, Lactobacillus casei, Enterococcus faecium, Bifidobacterium bifidium, Propionibacterium acidipropionici, Propionibacteriium freudenreichii, and Bifidobacterium pseudolongum.

In alternate embodiments, the additional agent may be one or more enzymes or enzyme variants. Suitable non-limiting examples of enzymes include amylases, carbohydrases, cellulases, esterases, galactonases, galactosidases, glucanases, hemicellulases, hydrolases, lipases, oxidoreductases, pectinases, peptidases, phosphatases, phospholipases, phytases, proteases, transferases, xylanases, or combinations thereof.

In further embodiments, the additional agent may be one or more herbals. Suitable herbals and herbal derivatives, as used herein, refer to herbal extracts, and substances derived from plants and plant parts, such as leaves, flowers, and roots, without limitation. Non-limiting exemplary herbals and herbal derivatives include agrimony, alfalfa, aloe vera, amaranth, angelica, anise, barberry, basil, bayberry, bee pollen, birch, bistort, blackberry, black cohosh, black walnut, blessed thistle, blue cohosh, blue vervain, boneset, borage, buchu, buckthorn, bugleweed, burdock, capsicum, cayenne, caraway, cascara sagrada, catnip, celery, centaury, chamomile, chaparral, chickweed, chicory, chinchona, cloves, coltsfoot, comfrey, cornsilk, couch grass, cramp bark, culver's root, cyani, cornflower, damiana, dandelion, devils claw, dong quai, echinacea, elecampane, ephedra, eucalyptus, evening primrose, eyebright, false unicorn, fennel, fenugreek, figwort, flaxseed, garlic, gentian, ginger, ginseng, golden seal, gotu kola, gum weed, hawthorn, hops, horehound, horseradish, horsetail, hoshouwu, hydrangea, hyssop, iceland moss, irish moss, jojoba, juniper, kelp, lady's slipper, lemon grass, licorice, lobelia, mandrake, marigold, marjoram, marshmallow, mistletoe, mullein, mustard, myrrh, nettle, oatstraw, oregon grape, papaya, parsley, passion flower, peach, pennyroyal, peppermint, periwinkle, plantain, pleurisy root, pokeweed, prickly ash, psyllium, quassia, queen of the meadow, red clover, red raspberry, redmond clay, rhubarb, rose hips, rosemary, rue, safflower, saffron, sage, St. John's wort, sarsaparilla, sassafras, saw palmetto, scullcap, senega, senna, shepherd's purse, slippery elm, spearmint, spikenard, squawvine, stillingia, strawberry, taheebo, thyme, uva ursi, valerian, violet, watercress, white oak bark, white pine bark, wild cherry, wild lettuce, wild yam, willow, wintergreen, witch hazel, wood betony, wormwood, yarrow, yellow dock, yerba santa, yucca, or combinations thereof.

In still other embodiments, the additional agent may be one or more natural pigments. Suitable pigments include, without limit, actinioerythrin, alizarin, alloxanthin, β-apo-2′-carotenal, apo-2-lycopenal, apo-6′-lycopenal, astacein, astaxanthin, azafrinaldehyde, aacterioruberin, aixin, α-carotine, β-carotine, γ-carotine, β-carotenone, canthaxanthin, capsanthin, capsorubin, citranaxanthin, citroxanthin, crocetin, crocetinsemialdehyde, crocin, crustaxanthin, cryptocapsin, α-cryptoxanthin, β-cryptoxanthin, cryptomonaxanthin, cynthiaxanthin, decaprenoxanthin, dehydroadonirubin, diadinoxanthin, 1,4-diamino-2,3-dihydroanthraquinone, 1,4-dihydroxyanthraquinone, 2,2′-diketospirilloxanthin, eschscholtzxanthin, eschscholtzxanthone, flexixanthin, foliachrome, fucoxanthin, gazaniaxanthin, hexahydrolycopene, hopkinsiaxanthin, hydroxyspheriodenone, isofucoxanthin, loroxanthin, lutein, luteoxanthin, lycopene, lycopersene, lycoxanthin, morindone, mutatoxanthin, neochrome, neoxanthin, nonaprenoxanthin, OH-Chlorobactene, okenone, oscillaxanthin, paracentrone, pectenolone, pectenoxanthin, peridinin, phleixanthophyll, phoeniconone, phoenicopterone, phoenicoxanthin, physalien, phytofluene, pyrrhoxanthininol, quinones, rhodopin, rhodopinal, rhodopinol, rhodovibrin, rhodoxanthin, rubixanthone, saproxanthin, semi-α-carotenone, semi-β-carotenone, sintaxanthin, siphonaxanthin, siphonein, spheroidene, tangeraxanthin, torularhodin, torularhodin methyl ester, torularhodinaldehyde, torulene, 1,2,4-trihydroxyanthraquinone, triphasiaxanthin, trollichrome, vaucheriaxanthin, violaxanthin, wamingone, xanthin, zeaxanthin, a-zeacarotene, or combinations thereof.

In yet other embodiments, the additional agent may be one or more antibiotics approved for use in livestock and poultry (i.e., antibiotics not considered critical or important for human health). Non-limiting examples of approved antibiotics include bacitracin, carbadox, ceftiofur, enrofloxacin, florfenicol, laidlomycin, linomycin, oxytetracycline, roxarsone, tilmicosin, tylosin, and virginiamycin.

### (V) Feed Rations

Yet another aspect of the present disclosure encompasses animal feed rations comprising any of the compositions described in Sections (I) or (II), or a feed premix as described in Section (III), as well as nutritional agents that provide protein, carbohydrate, and/or fat to the animal.

Feed ingredients that may be utilized in the present disclosure to satisfy an animal's maintenance energy requirements may include feed ingredients that are commonly provided to animals for consumption. Examples of such feed ingredients include grains, forage products, feed meals, feed concentrates, and the like.

Suitable grains include corn, corn gluten meal, soybeans, soybean meal, wheat, barley, oats, sorghum, rye, rice, and other grains, and grain meals.

Forage products are feed ingredients such as vegetative plants in either a fresh (pasture grass or vegetation), dried, or ensiled state and may incidentally include minor proportions of grain (e.g., kernels of corn that remain in harvested corn plant material after harvest). Forage includes plants that have been harvested and optionally fermented prior to being provided to ruminants as a part of their diet. Thus, forage includes hay, haylage, and silage. Examples of hay include harvested grass, either indigenous to the location of the ruminants being fed or shipped to the feeding location from a remote location. Non-limiting examples of hay include alfalfa, Bermuda grass, bahia grass, limpo grass, rye grass, wheat grass, fescue, clover, and the like as well as other grass varieties that may be native to the location of the ruminants being provided the ruminant feed ration.

It is beneficial if the forage is relatively high quality (i.e., contains relatively levels of metabolizable nutrients which permit the animal to satisfy its nutrient and maintenance energy requirements before reaching its consumption capacity). If the forage is of low quality, the animal may not metabolize it adequately to achieve desired performance effects (e.g., satisfy its nutrient and/or maintenance energy requirements), not only compromising the nutritional benefit from the forage per se, but also causing the animal to feel full or bloated, and possibly deterring it from consuming sufficient nutrients.

Haylage is a forage product that has been naturally fermented by harvesting a hay crop while the sap is still in the plant. The harvested hay or hay bales are then stored in an air-tight manner in which fermentation can occur. The fermentation process converts the sugars in the plants into acids which lower the pH of the harvested hay and preserves the forage.

Silage, similar to haylage, is a forage product that is produced from the harvest, storage and fermentation of green forage crops such as corn and grain sorghum plants. These crops are chopped, stems and all, before the grain is ready for harvest. The plant material is stored in silos, storage bags, bunkers, or covered piles causing the material to ferment, thereby lowering the pH and preserving the plant material until it can be fed.

Forage products also include high fiber sources and scrap vegetation products such as green chop, corncobs, plant stalks, and the like.

Feed concentrates are feedstuffs that are high in energy and low in crude fiber. Concentrates also include a source of one or more ingredients that are used to enhance the nutritional adequacy of a feed supplement mix, such as vitamins and minerals.

The feed ration may be supplemented with a fat source. Non-limiting fats include plant oils, fish oils, animal fats, yellow grease, fish meal, oilseeds, distillers' grains, or combinations thereof. The fat source will generally comprise from about 1% to about 10% of the dry mass of the total feed ration, more preferably from about 2% to about 6%, and most preferably from about 3% to about 4%.

Feed rations of the present disclosure typically are formulated to meet the nutrient and energy demands of a particular animal. The nutrient and energy content of many common animal feed ingredients have been measured and are available to the public. The National Research Council has published books that contain tables of common ruminant feed ingredients and their respective measured nutrient and energy content. Additionally, estimates of nutrient and maintenance energy requirements are provided for growing and finishing cattle according to the weight of the cattle. National Academies of Sciences, Engineering, and Medicine. 2016. Nutrient Requirements of Beef Cattle: Eighth Revised Edition. Washington, DC: The National Academies Press, pp. 396-403, which is incorporated herein in its entirety. This information can be utilized by one skilled in the art to estimate the nutritional and maintenance energy requirements of animal and determine the nutrient and energy content of animal feed ingredients.

### (VI) Methods for Improving Animal Health and Performance

Yet another aspect of the present disclosure encompasses methods of providing the compositions disclosed herein to animals for improving animal health and performance. In some embodiments, the method comprises administering any of the compositions described above in Sections (I) or (II), any of the feed premixes described in Section (IV), or any of the feed rations described in Section (V) for increasing methionine bioavailability, wherein increased methionine bioavailability is assessed by an improvement in at least one animal performance parameter. Suitable performance parameters include increased weight gain, increased feed conversion ratios, increased muscle mass, increased milk production, etc. as compared to animals that were only administered the source of methionine.

In other embodiments, the method comprises administering any of the compositions described above in Sections (I) or (II), any of the feed premixes described in Section (IV), or any of the feed rations described in Section (V) to a ruminant for increasing fermentation in the ruminant, wherein increased fermentation is assessed by increased levels of volatile fatty acids as compared to ruminants that were only administered the source of methionine.

In additional embodiments, the method comprises administering any of the compositions described above in Sections (I) and (II), any of the feed premixes described in Section (IV), or any of the feed rations described in Section (V) to lactating ruminants for increasing milk fat, milk protein, and/or milk yield as compared to lactating ruminants that were only administered the source of methionine.

The amount of the composition administered to the animal can and will vary depending on the type of animal, age and/or sex of the animal, and overall health of the animal. Those of skill in the art are familiar with methods for determining the amount of the composition to administer to the animal of interest.

Suitable animals include, but are not limited to, livestock or agricultural animals, companion animals, zoological animals, and research animals. In one embodiment, the animal may be a livestock or agricultural animal. Non-limiting examples of suitable livestock or agricultural animals may include cows, cattle, pigs, goats, sheep, poultry, llamas, alpacas, aquatic animals (e.g., farmed fish and shellfish), and the like. In yet another embodiment, the subject may be a companion animal. Non-limiting examples of companion animals may include pets such as dogs, cats, horses, rabbits, and birds. In yet another embodiment, the subject may be a zoological animal. As used herein, a “zoological animal” refers to an animal that may be found in a zoo. Such animals may include non-human primates, large cats, wolves, bears, hippos, kangaroos, etc. In still another embodiment, the animal may be a research or laboratory animal. Non-limiting examples of a research of laboratory animal include rodents (e.g., mice, rats, guinea pigs, hamsters, etc.), canines, felines, and non-human primates. In certain embodiments, the animal may be bovine, porcine, equine, ovine, or poultry. In other embodiments, the animal may be a ruminant, such as cattle, sheep, or goat. In one embodiment, the animal may be bovine. In another embodiment, the animal may be a non-ruminant, such as pigs or poultry.

### (VII) Specific Compositions and Methods of the Disclosure

Accordingly, the present disclosure relates to the following non-limiting compositions and methods.

In a first composition, Composition 1, the present disclosure provides a composition comprising a source of methionine and at least two essential oils.

In another composition, Composition 2, the present disclosure provides a composition, as provided in Composition 1, wherein the source of methionine comprises compounds of Formula (I):

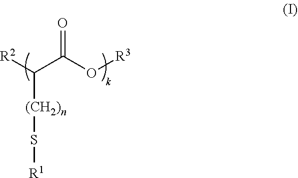

wherein R¹ is methyl or ethyl; R² is NH₂ or OH; R³ is hydrogen, C₁-C₆ alkyl, or a metal ion; k is an integer from 1 to 10; and n is an integer of 1 or 2.

In another composition, Composition 3, the present disclosure provides a composition, as provided in Composition 2, wherein the metal ion at R³ is calcium, chromium, cobalt, copper, iron, magnesium, manganese, silver, sodium, or zinc.

In another composition, Composition 4, the present disclosure provides a composition, as provided in either Compositions 2 or 3, wherein R¹ is methyl and n is 2.

In another composition, Composition 5, the present disclosure provides a composition, as provided in any one of Compositions 2 to 4, wherein R² is OH.

In another composition, Composition 6, the present disclosure provides a composition, as provided in any one of Compositions 2 to 5, wherein k is from 1 to 5.

In another composition, Composition 7, the present disclosure provides a composition, as provided in any one of Compositions 2 to 5, wherein k is 1.

In another composition, Composition 8, the present disclosure provides a composition, as provided in any one of Compositions 2 to 7, wherein R³ is calcium.

In another composition, Composition 9, the present disclosure provides a composition, as provided in any one of Compositions 1 to 8, wherein the at least two essential oils are chosen from allicin, amyl cinnamic aldehyde, amyl salicylate, anethole, anisic aldehyde, borneol, bornyl acetate, cadinene, camphene, camphor, carvacrol, carveol, carvone, cinnamaldehyde, cineol, citral, citronellal, citronellol, cuminic alcohol, cuminic aldehyde, cymene, dipentene, estragol, ethyl vanillin, eucalyptol, eugenol, eugenyl acetate, geraniol, geranyl acetate, guaiacol, isoeugenol, limonene, linalool, linalyl acetate, listea cubea, menthol, menthyl salicylate, methylchavicol, methyl salicylate, paracymene, perillaldehyde, phellandrene, pinene, piperonal, piperonyl acetate, piperonyl alcohol, pulegone, sabinene, terpinene, terpineol, terpinyl acetate, thujone, thymol, vanillin, or combinations thereof.

In another composition, Composition 10, the present disclosure provides a composition, as provided in any one of Compositions 1 to 9, wherein the at least two essential oils comprise cinnamaldehyde and garlic oil.

In another composition, Composition 11, the present disclosure provides a composition, as provided in any one of Compositions 1 to 9, wherein the at least two essential oils consist of cinnamaldehyde and garlic oil.

In another composition, Composition 12, the present disclosure provides a composition, as provided in any one of Compositions 1 to 9, wherein the at least two essential oils comprise thymol and carvacrol.

In another composition, Composition 13, the present disclosure provides a composition, as provided in any one of Compositions 1 to 9, wherein the at least two essential oils consist of thymol and carvacrol.

In another composition, Composition 14, the present disclosure provides a composition, as provided in any one of Compositions 1 to 13, wherein the least two essential oils are present in an amount from about 0.1% to about 10% by weight of the composition.

In another composition, Composition 15, the present disclosure provides a composition, as provided in any one of Compositions 1 to 14, wherein the at least two essential oils are present in an amount from about 0.5% to about 2% by weight of the composition.

In another composition, Composition 16, the present disclosure provides a composition comprising a source of methionine and a plurality of coated particles, the plurality of coated particles comprising at least one essential oil.

In another composition, Composition 17, the present disclosure provides a composition, as provided in Composition 16, wherein the source of methionine comprises compounds of Formula (I):

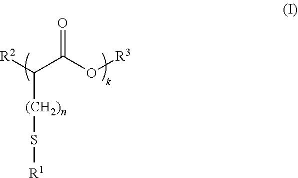

wherein R¹ is methyl or ethyl; R² is NH₂ or OH; R³ is hydrogen, Cᵢ-C₆ alkyl, or a metal ion; k is an integer from 1 to 10; and n is an integer of 1 or 2.

In another composition, Composition 18, the present disclosure provides a composition, as provided in Composition 17, wherein the metal ion at R³ is calcium, chromium, cobalt, copper, iron, magnesium, manganese, silver, sodium, or zinc.

In another composition, Composition 19, the present disclosure provides a composition, as provided in either Compositions 17 or 18, wherein R¹ is methyl and n is 2.

In another composition, Composition 20, the present disclosure provides a composition, as provided in any one of Compositions 17 to 19, wherein R² is

OH.

In another composition, Composition 21, the present disclosure provides a composition, as provided in any one of Compositions 17 to 20, wherein k is from 1 to 5.

In another composition, Composition 22, the present disclosure provides a composition, as provided in any one of Compositions 17 to 21, wherein k is 1.

In another composition, Composition 23, the present disclosure provides

In another composition, Composition 24, the present disclosure provides a composition, as provided in any one of Compositions 16 to 23, wherein the at least one essential oil is chosen from allicin, amyl cinnamic aldehyde, amyl salicylate, anethole, anisic aldehyde, borneol, bornyl acetate, cadinene, camphene, camphor, carvacrol, carveol, carvone, cinnamaldehyde, cineol, citral, citronellal, citronellol, cuminic alcohol, cuminic aldehyde, cymene, dipentene, estragol, ethyl vanillin, eucalyptol, eugenol, eugenyl acetate, geraniol, geranyl acetate, guaiacol, isoeugenol, limonene, linalool, linalyl acetate, listea cubea, menthol, menthyl salicylate, methylchavicol, methyl salicylate, paracymene, perillaldehyde, phellandrene, pinene, piperonal, piperonyl acetate, piperonyl alcohol, pulegone, sabinene, terpinene, terpineol, terpinyl acetate, thujone, thymol, vanillin, or combinations thereof.

In another composition, Composition 25, the present disclosure provides a composition, as provided in any one of Compositions 16 to 24, wherein the at least one essential oil is present in an amount from about 40% to about 60% by weight of the plurality of coated particles.

In another composition, Composition 26, the present disclosure provides a composition, as provided in any one of Compositions 16 to 25, wherein the at least one essential oil is present in an amount of about 50% by weight of the plurality of coated particles.

In another composition, Composition 27, the present disclosure provides a composition, as provided in any one of Compositions 16 to 26, wherein the plurality of coated particles comprise a core comprising the at least one essential oil and a protective coating layered over the core.

In another composition, Composition 28, the present disclosure provides a composition, as provided in Composition 27, wherein the core is inert.

In another composition, Composition 29, the present disclosure provides a composition, as provided in Compositions 27 or 28, wherein the core comprises organic material, inorganic material, or a combination thereof.

In another composition, Composition 30, the present disclosure provides a composition, as provided in any one of Compositions 27 to 29, wherein the core comprises silicon dioxide, aluminum oxide, calcium oxide, magnesium oxide, titanium oxide, zinc oxide, clays, metal oxides, metal silicates, metal carbonates, metal phosphonates, metal sulfates, metal carbides, metal nitrides, or combination thereof.

In another composition, Composition 31, the present disclosure provides a composition, as provided in any one of Compositions 27 to 30, wherein the core comprises silicon dioxide.

In another composition, Composition 32, the present disclosure provides a composition, as provided in any one of Compositions 27 to 31, wherein the core has an average particle size from about 80 microns to about 500 microns.

In another composition, Composition 33, the present disclosure provides a composition, as provided in any one of Compositions 27 to 32, wherein the protective coating comprises fatty acids, monoglycerides of fatty acids, diglycerides of fatty acids, esters thereof, or combinations thereof.

In another composition, Composition 34, the present disclosure provides a composition, as provided in any one of Compositions 27 to 33, wherein the protective coating comprises a mixture of mono- and diglycerides of long chain fatty acids or esters thereof.

In another composition, Composition 35, the present disclosure provides a composition, as provided in Composition 34, wherein the mixture comprises mono- and diglycerides of stearic acid and/or palmitic acid.

In another composition, Composition 36, the present disclosure provides a composition, as provided in any one of Compositions 27 to 35, wherein the protective coating is present in an amount from about 10% to about 15% by weight of the plurality of coated particles.

In another composition, Composition 37, the present disclosure provides a composition, as provided in any one of Compositions 27 to 36, wherein the wherein the protective coating is present in an amount of about 13% by weight of the plurality of coated particles.

In another composition, Composition 38, the present disclosure provides a composition, as provided in any one of Compositions 16 to 37, wherein the source of methionine is present in an amount from about 90% to about 99% by weight of the composition, and the plurality of coated particles is present in an amount from about 1% to about 10% by weight of the composition.

In another composition, Composition 39, the present disclosure provides a composition, as provided in any one of Compositions 16 to 38, wherein the source of methionine is present in an amount from about 96% to about 97% by weight of the composition, and the plurality of coated particles is present in an amount from about 3% to about 4% by weight of the composition of the composition.

In another composition, Composition 40, the present disclosure provides a composition, as provided in any one of Compositions 16 to 39, wherein the plurality of coated particles comprises or consists of two essential oils.

In another composition, Composition 41, the present disclosure provides a composition, as provided in Composition 40, wherein the two essential oils are cinnamaldehyde and garlic oil.

In another composition, Composition 42, the present disclosure provides a composition, as provided in Composition 41, wherein cinnamaldehyde is present in an amount of about 1.5% by weight of the composition, and garlic oil is present in an about of about 0.25% by weight of the composition.

In another composition, Composition 43, the present disclosure provides a composition, as provided in Composition 40, wherein the two essential oils are thymol and carvacrol.

In another composition, Composition 44, the present disclosure provides a composition, as provided in Composition 43, wherein thymol is present in an amount of about 0.875% by weight of the composition, and carvacrol is present in an about of about 0.875% by weight of the composition.

In another composition, Composition 45, the present disclosure provides a composition, as provided in any one of Compositions 1 to 44, which is a free flowing powder.

In another composition, Composition 46, the present disclosure provides a feed premix comprising the composition of any one of Compositions 1 to 45.

In another composition, Composition 47, the present disclosure provides a feed premix, as provided in Composition 46, wherein the feed premix further comprises at least one agent chosen from vitamins, minerals, amino acids, amino acid analogs, antioxidants, organic acids, polyunsaturated fatty acids, enzymes, prebiotics, probiotics, postbiotics, herbs, pigments, pharmaceutically active agents, or combinations thereof.

In another composition, Composition 48, the present disclosure provides a feed premix, as provided in Compositions 46 or 47, wherein the feed premix further comprises at least one nutritional agent chosen from protein sources, carbohydrate sources, fat sources, or combination thereof.

In a first method, Method 1, the present disclosure provides a method for increasing methionine bioavailability in an animal, wherein the method comprises administering the composition of any one of Compositions 1 to 48 to the animal, and wherein the animal has at least one improved performance parameter as compared to an animal administered only the source of methionine.

In another method, Method 2, the present disclosure provides a method, as provided in Method 1, wherein the animal is a livestock animal, a companion animal, zoological animal, or a research animal.

In another method, Method 3, the present disclosure provides a method, as provided in Methods 1 or 2, wherein the animal is bovine, porcine, equine, ovine, or poultry.

In another method, Method 4, the present disclosure provides a method for increasing fermentation in a ruminant, wherein the method comprises administering the composition of any one of Compositions 1 to 48 to the ruminant, and wherein the ruminant has an increased level of volatile fatty acids as compared to a ruminant administered only the source of methionine.

In another method, Method 5, the present disclosure provides a method, as provided in Method 4, wherein the ruminant is bovine.

In another method, Method 6, the present disclosure provides a method for increasing milk fat, milk protein, and/or mild yield in a lactating ruminant, wherein the method comprises administering the composition of any one of Compositions 1 to 48 to the lactating ruminant, and wherein the lactating ruminant has an increased milk fat, milk protein, and/or milk yield as compared to a lactating ruminant administered only the source of methionine.

In another method, Method 7, the present disclosure provides a method, as provided in Method 6, wherein the lactating ruminant is a milk cow.

### EXAMPLES

The following examples illustrate various embodiments of the present disclosure.

### Example 1: Preparation of Thymol-Carvacrol Particles

An essential oil solution was prepared by mixing 750 g of carvacrol and 750 g of thymol. The solution was sprayed onto 1100 g of microgranular silica spheres (e.g., SIPERNAT® 2200) in a fluid bed reactor. A coating solution was prepared by melting 390 g of a mixture of mono- and diglycerides of stearic acid, and the coating solution was deposited on the oil-loaded spheres by spraying at about 75° C.

### Example 2: Preparation of Cinnamaldehyde-Garlic Oil Particles

Cinnamaldehyde-garlic oil particles were prepared essentially as described above in Example 1 except the essential oil solution contained 1290 g of cinnamaldehyde and 210 g of garlic oil.

The starting silica spheres had a D90 of 426 microns, D50 of 217 microns, and D10 of 33 microns. The finished essential oil particles had a D90 of 579 microns, a D50 of 374 microns, and a D10 of 224 microns.

### Example 3: Evaluation of Composition Comprising Essential Oil Particles

A composition (i.e., composition #1) was prepared by mixing 965 kg of calcium salt of methionine hydroxy analog (i.e., MHA) and 35 kg of cinnamaldehyde-garlic oil particles. The performance of composition #1 was compared to that of MHA alone in a single-flow continuous culture system. This system used forty-eight 2-L fermenters kept at 39° C. and continuously stirred. Buffer solution (McDougall's buffer) and rumen fluid obtained from two fistulated Holstein cows fed a common diet were added (1,460 mL) to each fermenter in a 1:2 ratio at a target inflow and effluent rate of 6% per hour. Carbon dioxide was continuously flushed to the fermenters to maintain an anaerobic environment. Fermenters were fed 40 g of dry matter daily, split into 2 meals. These meals contained the individual components of the composition as well as the blend. Fermenters were allowed to run for a total of 10 days, with the first 7 days serving as an acclimation period and the last 3 days serving as time for sample collection. During sample collection effluent levels were recorded and one half of the effluent collected over the previous 24 h was taken as a subsample and frozen. These subsamples were compiled for each fermenter and stored for analysis. Fermenter pH was measured prior to feeding (0 h) and 0, 2, 4, and 8 h post feeding. At 0, 2, 4, and 8 h post feeding a 10 mL sample was taken from each fermenter and frozen at −20° C., composited by hour for each fermenter over the collection period, and analyzed. On 10 d of each fermenter run, fermenter contents were collected and stored at −20° C. for analysis. The levels of fatty acids in the samples were analyzed using standard procedures.

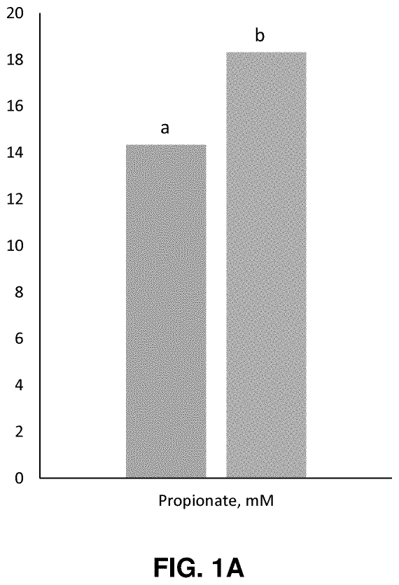

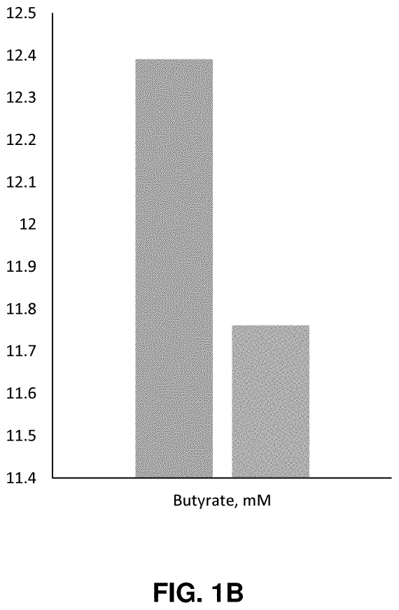

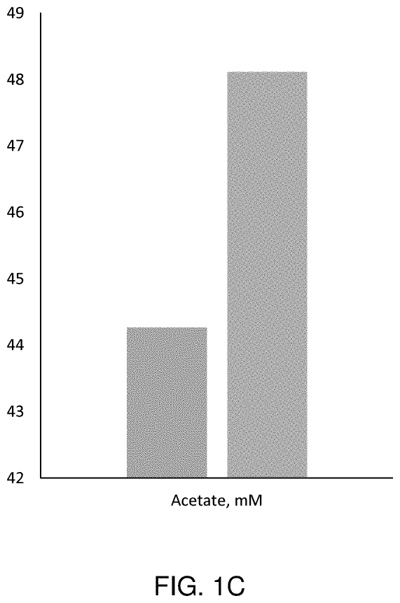

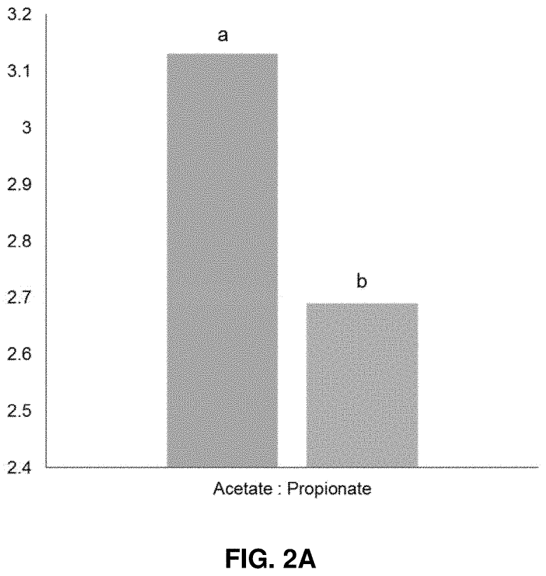

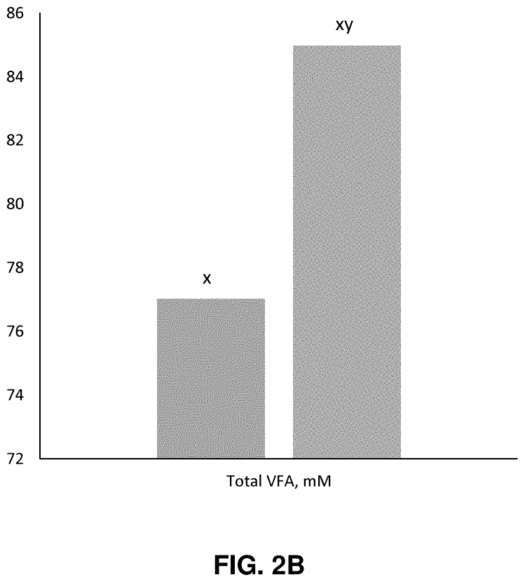

Composition #1 improved fermentation by increasing (by 10%) the levels of volatile fatty acids (i.e., end products of rumen fermentation) (see FIG. 2B). More specifically, propionate (i.e., the substrate from which glucose is made) was increased by about 27% (FIG. 1A) suggesting that the cow can make more glucose and possibly more lactose which will result in increased milk yield. This increase in milk yield for greater lactose concentrations is due to the role lactose has as an osmotic regulator for milk synthesis.

What is claimed is:

1. A composition comprising a source of methionine and a plurality of coated particles, the plurality of coated particles comprising at least one essential oil.

2. The composition of claim 1, wherein the source of methionine comprises compounds of Formula (I): 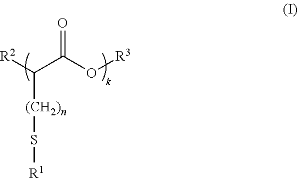
wherein:
R¹ is methyl or ethyl;
R² is NH₂ or OH;
R³ is hydrogen, C₁-C₆ alkyl, or a metal ion chosen from calcium, chromium, cobalt, copper, iron, magnesium, manganese, silver, sodium, or zinc;
k is an integer from 1 to 10; and
n is an integer of 1 or 2.

3. The composition of claim 2, wherein R¹ is methyl, R² is OH, R³ is calcium, k is from 1 to 5, and n is 2.

4. The composition of claim 1, wherein the source of methionine is present in an amount from about 90% to about 99% by weight of the composition, and the plurality of coated particles is present in an amount from about 1% to about 10% by weight of the composition.

5. The composition of claim 1, wherein the plurality of coated particles comprise a core comprising the at least one essential oil and a protective coating layered over the core.

6. The composition of claim 5, wherein the at least one essential oil is chosen from allicin, amyl cinnamic aldehyde, amyl salicylate, anethole, anisic aldehyde, borneol, bornyl acetate, cadinene, camphene, camphor, carvacrol, carveol, carvone, cinnamaldehyde, cineol, citral, citronellal, citronellol, cuminic alcohol, cuminic aldehyde, cymene, dipentene, estragol, ethyl vanillin, eucalyptol, eugenol, eugenyl acetate, geraniol, geranyl acetate, guaiacol, isoeugenol, limonene, linalool, linalyl acetate, listea cubea, menthol, menthyl salicylate, methylchavicol, methyl salicylate, paracymene, perillaldehyde, phellandrene, pinene, piperonal, piperonyl acetate, piperonyl alcohol, pulegone, sabinene, terpinene, terpineol, terpinyl acetate, thujone, thymol, vanillin, or combinations thereof.

7. The composition of claim 5, wherein the at least one essential oil is present in an amount from about 40% to about 60% by weight of the plurality of coated particles.

8. The composition of claim 5, wherein the core comprises silicon dioxide, aluminum oxide, calcium oxide, magnesium oxide, titanium oxide, zinc oxide, clays, metal oxides, metal silicates, metal carbonates, metal phosphonates, metal sulfates, metal carbides, metal nitrides, or combination thereof.

9. The composition of claim 5, wherein the core has an average particle size from about 80 microns to about 500 microns.

10. The composition of claim 5, wherein the core is present in an amount from about 30% to about 45% by weight of the plurality of coated particles.

11. The composition of claim 5, wherein the protective coating comprises fatty acids, monoglycerides of fatty acids, diglycerides of fatty acids, esters thereof, or combinations thereof.

12. The composition of claim 5, wherein the protective coating is present in an amount from about 10% to about 15% by weight of the plurality of coated particles.

13. The composition of claim 5, wherein the core comprises silicon dioxide and is present in an amount of about 37% by weight of the plurality of particles, the at least one essential oil comprises a combination of thymol and carvacrol or a combination of cinnamaldehyde and garlic oil and is present in an amount of about 50% by weight of the plurality of particles, and the protective coating comprises a mixture of mono- and diglycerides of long chain fatty acids or esters thereof and is present in an amount of about 13% by weight of the plurality of particles.

14. The composition of claim 13, wherein the source of methionine is present in an amount from about 96% to about 99% by weight of the composition, and the plurality of coated particles is present in an amount from about 1% to about 4% by weight of the composition of the composition.

15. The composition of claim 14, wherein the source of methionine is is 2-hydroxy-4-(methylthio)butanoic acid calcium salt.

16. The composition of claim 14, wherein thymol is present in an amount of about 0.875% by weight of the composition, and carvacrol is present in an about of about 0.875% by weight of the composition, or cinnamaldehyde is present in an amount of about 1.5% by weight of the composition, and garlic oil is present in an about of about 0.25% by weight of the composition.

17. A feed premix comprising the composition of claim 1 and at least one nutritional agent chosen from a protein source, a carbohydrate source, a fat source, or a combination thereof.

18. The feed premix of claim 17, further comprising. at least one agent chosen from vitamins, minerals, amino acids, amino acid analogs, antioxidants, organic acids, polyunsaturated fatty acids, enzymes, prebiotics, probiotics, postbiotics, herbs, pigments, pharmaceutically active agents, or combinations thereof.

19. A method for increasing methionine bioavailability in an animal, the method comprising administering the composition of claim 1 to the animal, wherein the animal has at least one improved performance parameter as compared to an animal administered only the source of methionine.

20. The method of claim 19, wherein the animal is a livestock animal, a companion animal, zoological animal, or a research animal.

21. A method for increasing fermentation in a ruminant, the method comprising administering the composition of claim 1 to the ruminant, wherein the ruminant has an increased level of volatile fatty acids as compared to a ruminant administered only the source of methionine.

22. The method of claim 21, wherein the ruminant is bovine.

23. A method for increasing milk fat, milk protein, and/or mild yield in a lactating ruminant, the method comprising administering the composition of claim 1 to the lactating ruminant, wherein the lactating ruminant has an increased milk fat, milk protein, and/or milk yield as compared to a lactating ruminant administered only the source of methionine.

24. The method of claim 23, wherein the lactating ruminant is a milk cow.
